(19) United States
(12) Patent Application Publication
(10) Pub. No.: US 2003/0131828 A1
(43) Pub. Date: Jul. 17, 2003

(54) In-tank fuel module inlet strainer with ESD protection

(75) Inventor: Lynwood F. Crary, Preston, CT (US)

Correspondence Address: Jenner & Block, 330 North Wabash Avenue, Chicago, IL, 60611, US

(73) Assignee: IT Group Automotive System LLC

(21) Appl. No.: 10/044,637

(22) Filed: Jan. 11, 2002

(51) Int. Cl. F02M 37/04

(52) U.S. Cl. 123/509

(57) ABSTRACT

An inlet strainer for an in-tank fuel pump that comprises a connection flange for connection to a fuel pump in overlying relation to a pump inlet, and a strainer body made of porous material secured to the connection flange that defines a hollow bag-like structure. At least a portion of the strainer body is made of electrically conductive material. The strainer body is made of non-conductive polymeric material rendered conductive through inclusion of conductive material. The strainer body is connected to a conductive ground link adapted to connect to a ground plane.

This invention relates to fuel system in-tank modules. More particularly, it relates to fuel system in-tank modules having an electrostatic discharge protection mechanism.

Modern vehicular fuel systems include fuel injectors that deliver fuel to the engine. The fuel supply is contained in a tank usually located at some distance from the engine. A pump and filter, in a modular unit, are often located in the tank, to deliver pressurized and filtered fuel to the engine.

Two common systems are employed: one is a two-pipe, or return system; the other is a one-pipe, or returnless system. Both involve fuel at high pressure and flow rates.

Many of the system components, including the tank and connecting hose or tubing, as well as associated coupling devices, are made of plastic materials, such as nylon or acetel, that are non-conductive. The fuel, because of the flow rates (velocity) involved, can generate electrostatic charges while passing through elements of the system. Various grounding techniques are employed to ensure that these charges do not accidentally discharge.

In-tank fuel modules include a reservoir to contain a quantity of fuel. It also houses a fuel pump driven by an electric motor, a filter that separates impurities from the fuel to be delivered to the engine and a pressure regulator to maintain the delivered fuel at a predetermined pressure. In a returnless system, the regulator also modulates flow. Most in-tank modules also include an aspirator or venturi pump that employs pressurized fuel from the regulator bypass to siphon fuel, resident in the tank, into the module reservoir.

Fuel movement within the in-tank module, particularly through the filter media and the usually arduous path between the pump discharge and the filter housing and thereafter, makes the fuel particularly susceptible to buildup of electrostatic charges. Efforts have been employed to provide a ground path from these module components to the vehicle ground.

Examples of structures intended to dissipate electrostatic charge in fuel systems for fuel injected engines are found in U.S. Pat. Nos. 5,076,920, 5,164,084 and 5,164,879. These patents disclose in-line fuel filters with housings made of non-conductive plastic, rendered conductive by the addition, in the plastic component, of conductive fibers such as stainless steel fibers. The housing is grounded to the vehicle electrical system by a conductive path formed of a separate metal bracket or molded as part of the housing.

Another approach employed for in-line filters is to coat the interior and exterior of the fuel filter housing with a conductive layer, such as a metal coating. The surface layer is connected to the vehicle ground. This arrangement is disclosed in U.S. Pat. No. 5,382,359.

Other arrangements intended to dissipate electrostatic charges from vehicular fuel systems are illustrated in U.S. Pat. Nos. 5,785,032 and 6,047,685. In each system, components carrying fuel under pressure and subject to turbulent flow, such as the fuel filter, are rendered conductive through use of conductive material in an otherwise non-conductive member formed of plastic resin. Both disclose connection of the conductive components to ground to ensure dissipation of electrostatic charges.

Another known effort addresses the concentration of electrostatic charge associated with flow through the filter media of a fuel filter in a fuel injection system fuel system. This arrangement employs a conductive mesh surrounding the exterior of the filter media, which is connected to ground. The mesh may be made of metal or a polymeric resin, such as nylon, or acetel, impregnated with conductive material, such as carbon powder.

These various approaches share a common principle. Each focuses on addressing charge minimization or dissipation in the portions of the system, downstream of the pump, containing fuel at elevated pressure.

U.S. Pat. Nos. 3,933,643 and 5,380,432 disclose use of conductive fibrous material within a filter medium. The filters disclosed are located in the pressurized path of flow.

U.S. Pat. No. 5,10,764 discloses an in-tank fuel system with a screen at the inlet of the pump that is made of metal. This screen is not disclosed as intended to provide any protection against electrostatic discharge, and is not disclosed to be connected to the vehicle ground plane.

It has not previously been recognized that a significant contribution to dissipation or minimization of charge buildup can be achieved by employing a conductive ground path at the initial entry of the fuel to the system pump from an area where fuel pressure is low.

The present invention is directed to providing that advantage.

### SUMMARY OF THE INVENTION

The invention is directed, in a fuel supply system having a container for a supply of fuel, a pump for pumping fuel from the container to the remainder of the system, and a motor to drive the pump, in which the pump has an inlet, open to the quantity of fuel in the container, to an electrostatic charge and dissipation accumulation mechanism including a porous member interposed between the supply of fuel in the tank and the inlet to the pump, at least a portion of the porous member being conductive, and a grounding member connected to the porous member and adapted to be connected to a ground plane.

The method further embraces a method of providing protection against electrostatic discharge in a fuel supply system having a container containing a quantity of fuel, a pump for pumping the fuel from the container to the remainder of the fuel supply system, and a motor to drive the pump, wherein the pump has an inlet open to the quantity of fuel in the container, which method comprises the steps of: providing an electrostatic charge accumulation and dissipation mechanism, including a porous member, at least a portion of which is conductive, and a grounding member connected to the porous member and adapted to be connected to a ground plane, interposing the porous member between the fuel in the tank and the pump inlet and connecting the grounding member to a ground plane.

In accordance with the present invention, an inlet strainer is provided for an in-tank fuel pump that comprises a connection flange for connection to a fuel pump in overlying relation to a pump inlet, and a strainer body made of porous material secured to the connection flange to define a hollow bag-like filter. At least a portion of the body is made of electrically conductive material. The strainer body is connected to a ground link adapted to connect to ground.

### DESCRIPTION OF THE DRAWINGS

FIG. 1 is a sectional, elevational view of an in-tank fuel module incorporating the principles of the present invention.

FIG. 2 is a fragmentary, sectional, elevational view, on an enlarged scale, of a portion of the apparatus of FIG. 1, illustrating an inlet strainer embodying the present invention.

FIG. 3 is a fragmentary exploded view of a portion of the inlet strainer of FIG. 2, showing details thereof.

FIG. 4 is a top view of the inlet strainer of FIG. 2, and

FIG. 5 is a fragmentary exploded view of a modified form of inlet strainer embodying the present invention.

### DETAILED DESCRIPTION OF ILLUSTRATED EMBODIMENTS

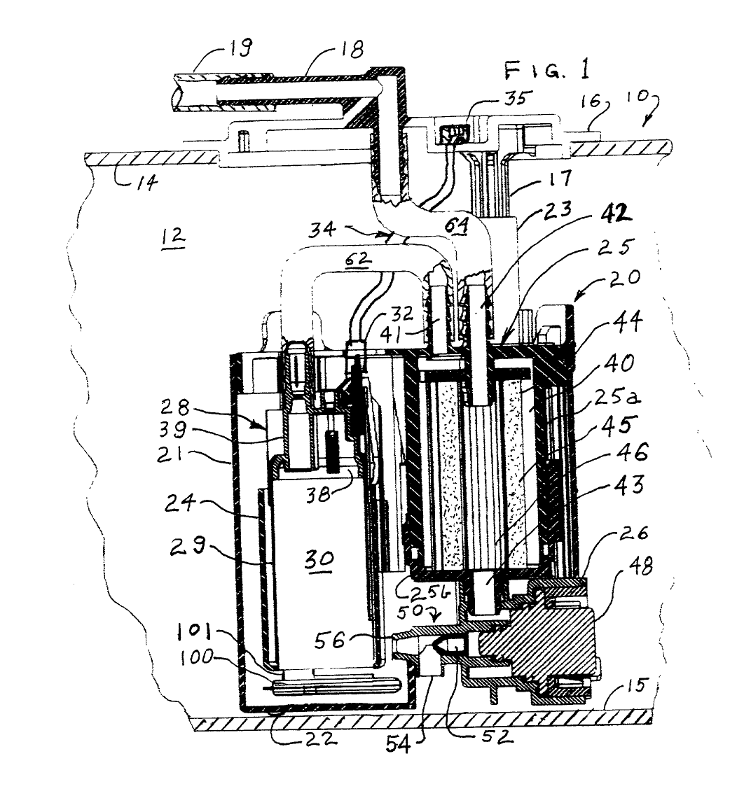

Referring to FIG. 1, there is illustrated an in-tank fuel module generally designated 10 adapted to deliver fuel to an internal combustion engine fuel injection system. While the fuel system is usually employed in the context of a vehicular engine, the principles apply in other applications, including stationary installations.

The module 10 is disposed within a fuel tank 12. The tank is made of a polyethylene-based material such as HDPE, and includes an upper wall 14 and a bottom wall 15. Wall 14 defines an opening sized to receive the module 10.

The in-tank module 10 is comprised of two major components, a tank flange 16 connected to wall 14 and a reservoir 20 which rests on bottom wall 15. The tank flange 16 is sized to close the opening in the upper wall 14 of the tank. It may be made of the same material as the tank. It is releasably secured to wall 14 in fluid-tight relation. Alternatively, the tank flange may be made of a polymeric resin, such as acetel, and releasably secured to the tank in fluid-tight relation by known methods. A hollow splined shaft or tube 17 extends downwardly from an under surface of the flange 16. A fuel outlet from the module is defined by a connector 18 supported in flange 16. Connector 18 is connected to a fuel tube or line 19 which communicates fuel to the engine (not shown).

The reservoir 20 is disposed within tank 12. It defines a reservoir fuel container or can 21 to contain a quantity of fuel delivered from fuel tank 12, as will be explained. The reservoir can 21 includes dimples 22 formed in its bottom wall that rest on the interior of the bottom wall 15 of the fuel tank 12.

The reservoir 20 includes a tube 23 that slidably receives hollow splined shaft or tube 17. The reservoir 20 and tank flange 16 are connected to form a single assembly by the interconnection of the tube 17 and tube 23. This interconnection permits the relative spacing between the tank flange 16 and reservoir 20 to change to accommodate different tank dimensions between upper wall 14 and bottom wall 15. Although only one set of tubes 17 and 23 is illustrated in FIG. 1, a module usually includes three such connections between the flange 16 and reservoir 20. The hollow splined tube 17 and tube 23 may also provide a fuel return path used in a two line, or return system.

Reservoir 20 houses the major operating components of the in-tank fuel module 10. In this regard, it defines a motor/pump sleeve 24, a filter housing 25 and a regulator receptacle 26. The reservoir is made of molded plastic material, and these various elements are conventionally provided during the molding process. Some are formed of removable components, also made of molded polymeric material, such as nylon or acetel.

A motor/pump combination 28 is retained vertically in the motor/pump sleeve 24. It includes an electric motor 30 having a metal outer casing. The motor is coupled to a fuel pump 31, best seen in FIG. 2. The motor 30 is connected to a source of electrical power through a plug 32 and electrical wires or leads 34. These leads extend to another plug 35 in the tank flange 16. On installation, plug 35 is connected to the source of electrical power. One of the leads 34 connects to the negative terminal or ground plane of the electrical system. Internally of motor 30, the outer case 29, seen in FIG. 2, which is metal, such as plated steel, is connected electrically to the negative lead of the wires 34. The casing is, therefore, connected to the system ground plane.

Referring to FIG. 2, pump 31 is disposed at the bottom of the motor pump 28. It includes a pump inlet 36 open to the reservoir fuel can 21. The inlet is defined by a circular flange 37. The pump 31 pumps fuel from the reservoir fuel can 21 vertically upward through passages within the motor 30 to an upper chamber 38, seen in FIG. 1, defined by the housing of the motor/pump 28. A hollow pump outlet stem 39 extends upwardly from upper chamber 38.

Filter housing 25, formed of a top portion 25a and a base portion 25b, define a filter chamber 40. A hollow filter inlet stem 41 extends through an upper wall of the filter housing portion 25 and communicates with filter chamber 40. A flexible tube or hose 62 connects between pump outlet stem 39 and filter inlet stem 41. All fuel pressurized by pump 31 exits upper chamber 38 through pump outlet stem 39. It passes through tube 62 and enters filter housing 25 through filter inlet stem 41.

A centrally located hollow fuel supply stem 42 extends vertically upwardly from filter housing portion 25a. A centrally located hollow fuel bypass stem 43 extends downwardly from a bottom wall of filter housing portion 25b. It is open to the regulator receptacle 26 formed in reservoir 20 for purposes discussed later.

A filter cartridge 44 is disposed within filter chamber 40. It includes a porous filter media 45 that defines a central passage 46 in chamber 40. The separate portions 25a and 25b of the filter housing 25 permit installation and removal of the filter cartridge 44.

Cartridge 44 is appropriately sealed to the interior of the walls of the filter housing and with the fuel supply stem and fuel bypass stem, such that all fuel entering the filter chamber 40 must pass through the filter media 45 to the central passage 46.

Fuel in passage 46 may exit filter housing 25 through fuel supply stem 42 and fuel bypass stem 43. A flexible hose or tube 64 connects fuel supply stem 42 with connector 18. Supply fuel for consumption by the engine flows upwardly out of the central passage 46 of the filter cartridge 44, through fuel supply stem 42, tube 64, connector 18 and supply tube or line 19. Tubes or hose components 62 and 64 are made of extruded polymeric material, rendered conductive by use of carbon powder. The tubes are grounded to the system ground plane by a wire (not shown).

Regulator-modulator 48 is disposed in receptacle 26 formed in the side of reservoir can 21. It controls the pressure and flow of fuel to the engine through supply line 19 by bypassing fuel not required for consumption. The bypassed fuel returns to fuel tank 12 for later consumption.

The regulator-modulator 48 is a known device and its operation is not described here in detail. It is sufficient to understand that it is a normal component of a returnless fuel supply system.

Pressurized and filtered fuel to be bypassed by regulator-modulator 48 exits the fuel filter housing 25 through fuel bypass stem 43. The regulator-modulator then bypasses requisite quantities of fuel to an aspirator 50 located near the bottom of reservoir can 21.

The aspirator 50 includes a venturi nozzle 52, a venturi siphon inlet port 54 open to fuel tank 12 and a supply port 56 which is positioned within reservoir can 21. Supply port 56 is a fuel inlet supply access to the reservoir can. The can may also have a gravity feed with an umbrella check valve (not shown). Pressurized fuel exiting venturi nozzle 52 causes a siphon effect that draws fuel into the siphon inlet port 54. The fuel is discharged into the reservoir can 21 through supply port 56 to maintain the fuel level within can 21.

The supply port 56 is shown as disposed to deliver fuel near the bottom of the reservoir can 21, for clarity of understanding and illustration. It is usual for the port to be disposed upward to near the top of reservoir can 21 by use of an appropriately configured tube. With such an arrangement, which is common and well known, fuel cannot drain from reservoir can 21 when the system is not operating.

In operation, the electric motor 30 operates pump 31 to pressurize fuel drawn from reservoir can 21 through pump inlet 36. The pressurized fuel passes through pump outlet stem 39 and tube 62 into filer chamber 40 through filter inlet stem 41 of filter housing 25.

The pressurized fuel passes through filter media 45 of filter cartridge 44 where it is cleansed of particulate impurities. Fuel enters central passage 46. Fuel to be consumed by the engine passes upwardly through fuel supply stem 42, through tube 64, and connector 18 and supply hose 19 to the engine fuel injection system.

By-passed fuel, as controlled by the regulator-modulator 48, exits the central passage 46 through the regulator-modulator and is converted to a high velocity stream by venturi nozzle 52 of aspirator 50. The fuel stream draws fuel resident in tank 12 into aspirator 50 through siphon inlet port 54. That fuel combines with high velocity fuel from the venturi nozzle 52. The combined fuel stream enters the reservoir can 21 through supply port 56.

The system described is typical of a fuel system in-tank delivery module. As explained, various efforts have been employed to minimize or dissipate electrostatic charges that build within system components, particularly those where the fuel is turbulent, such as within the filter cartridge 44 or tubes 62 and 64. All such arrangements are employed in portions of the fuel system where the fuel is pressurized, i.e., beyond the discharge of fuel pump 31.

Most of the module components are made of polymeric material, such as the molded components of the reservoir 20, including can 21, motor/pump sleeve 24, regulator receptacle 26, filter housing portion 25a and 25b, and the extruded tubes 62 and 64. Many of these components are rendered conductive through use of polymeric material, such as nylon or acetel containing quantities of conductive material, such as metal fibers or carbon powder. One or more may be connected by a conductive wire or the like to the system ground plane.

Fuel from the reservoir can 21 enters the system described through the inlet 36 to the pump 31. That fuel resides in the tank at essentially the pressure within tank 12, which is near atmospheric pressure. As apparently not previously recognized, significant opportunity exists for generation of electrostatic charge. Movement of the fuel occurs within the reservoir can 21, because of the flow imparted by the aspirator 50. Also, the suction caused by the pump 31 moves the fuel through the pump inlet at the same rate as the pump discharge. It is not, however, subjected to the pressure experienced on the pressure side of the pump 31.

As best seen in FIG. 2, fuel enters the inlet 36 to pump 31 through an inlet strainer assembly 100. Strainer assembly 100 includes a connection flange 101, a rigid support member 102, and strainer body 106 made of porous, or mesh, material. The strainer body 106 is a bag-like structure, having a hollow interior 107. It is sized such that the area of openings through which fuel flows exceeds the area of the inlet 36 to fuel pump 31.

Connection flange 101 is a rigid annular collar. It includes an upper end sized to define a cylindrical opening 103 to be secured upon the cylindrical flange 37 of pump 31. Connection flange 101 is frictionally engaged on the flange 37 of pump 31. Lower end of connection flange 102 defines the flow path from the interior 107 of the strainer body 106 into the pump inlet 36. As best seen in FIGS. 2 and 4, an anti-rotation pin 109 also engages the motor/pump combination 28 to further secure the strainer assembly 100. The upwardly extending ground link 108 is configured such that its upper end contacts the exterior surface of the metal casing 29 of motor 30. Connection flange 101 also includes an upstanding ground link 108. The connection flange or collar 101 is also formed of conductive material. It may be an acetel or nylon molded part with contained carbon powder.

The rigid supporting member 102 extends in a generally horizontal direction, perpendicular to the vertical centerline of the annular connection flange 101. It includes a central spine 110 connected to the connection flange 101. It also has a plurality of ribs 111 that extend outward from the spine 110 and a plurality of depending legs 112 in the interior 107 of the hollow strainer body 106 to maintain the bag-like shape of the strainer body. A separate bottom disc 113, aligned with the lower end of connection flange 101, is connected to the bottom wall of strainer body 106. It includes spaced apart, upstanding spacers 103 to further insure that the mesh does not enter the inlet opening to pump 31.

Use of a rigid supporting member is only one optional structure to form the strainer 100. Any arrangement maybe employed that gives adequate rigidity and ensures that the interior 107 be maintained in an open bag-like configuration.

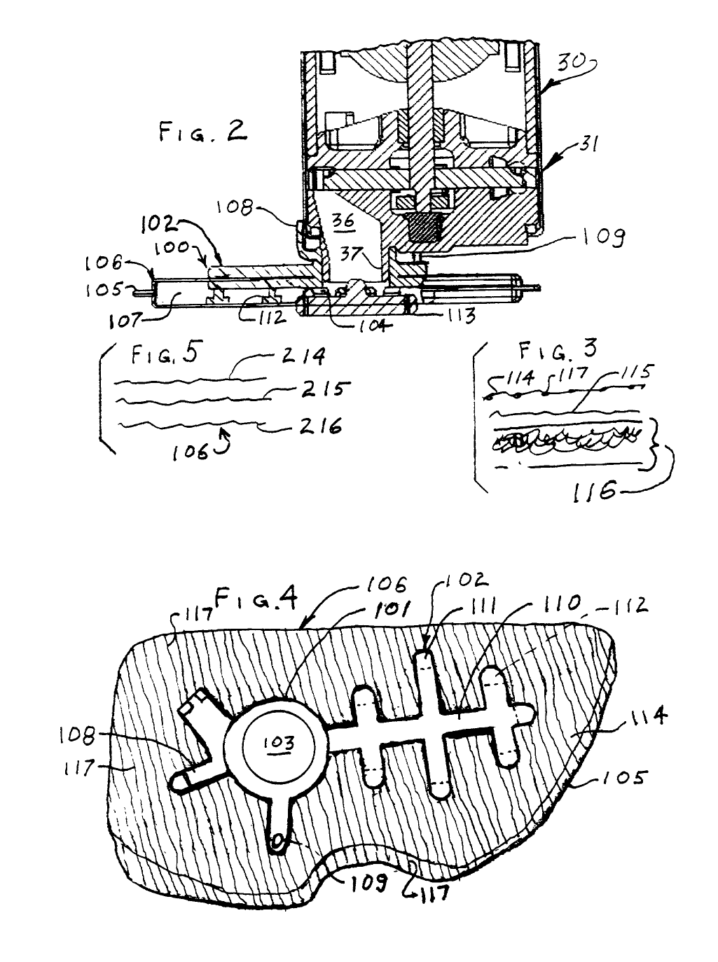

Strainer body 106 is a bag-like hollow structure formed of multiple layers of porous mesh overlying spine 110 and ribs 111 of the rigid support member 102. It defines an opening connected in surrounding relation to the connection flange 101. The body 106 is secured to the connection flange 101, rigid support member 102, central spine 110, ribs 111 and separate bottom disc 113 by overmolding these parts onto the mesh body 106 in any suitable molding process, such as injection molding. Any seams in the mesh of the body 106, such as edges 105, are closed by hot plate welding or other known means. As best seen in FIG. 3, the strainer body 106 is made of layers of porous mesh material defining minute openings through which fuel may flow from the fuel reservoir can 21 to the interior of the strainer body 106.

The porous mesh provides the initial filtration of fuel that passes from tank 12 into the pump 31 for pressurization and delivery to the remainder of the fuel system. Typically, the mesh is arranged to filter to about 30-31 micron particle size.

The interior 107 of the strainer body 106 is in communication with the inlet to the fuel pump 31 and fuel enters the pump for delivery to the fuel system. Depending legs 112 on the spine 110 and ribs 111, and spacers 104 on disc 113, insure that the body mesh maintains its hollow shape and chamber-like interior. Otherwise, the pump suction would pull the bottom wall of the strainer body 106 into the inlet of the pump, thereby reducing the effective surface area of the strainer body 106. The fuel, after having passed through the openings in the porous material, is filtered of impurities that cannot pass through the mesh size.

In accordance with the principles of the present invention, an electrostatic charge accumulation and dissipation mechanism is provided in the form of strainer body 106. It is made of a mesh material, at least a portion of which is electrically conductive. The conductive material may be a metal screen, a mesh made of conductive plastic impregnated with carbon or metal fibers, or any suitable material that can conduct electrical charges. Electrostatic charges that accumulate on, or adjacent, the strainer body 106 are effectively transferred or dissipated to the vehicle ground through the conductive strainer body 106, connection flange 101, rigid support member 102 and ground link 108, to the metal case 29 of motor 30. This is the manner in which the mechanism is thought to be effective. It may be, however, that its presence merely prevents build-up or accumulation of an electrostatic charge.

As best seen in FIG. 3, strainer body 106 of the embodiment of FIGS. 1 to 4, is made of an outer layer 114 of porous cloth of nylon mesh material, an intermediate layer 115 of nylon mesh material, and an inner layer 116, which is a composite layer.

The outer layer 114 of strainer body 106 is a 135-150 square weave spun-bonded mesh of nylon. The intermediate layer 115 is a smaller gauge nylon material.

Interior layer 116 is a layer of melt blown nylon depth media which includes non-woven inner and outer spun-bonded layers of Cerex® material 10 connected to a thickness of melt blown nylon media. (Cerex is a trademark of Cerex Advanced Fabrics, L.C.A.F., Inc.) Filter material as disclosed in U.S. Pat. No. 5,902,480, for example, is suitable for use as the material for strainer body 106. It, of course, must be modified as required for the present invention to provide a conductive path.

An inlet strainer, as described with reference to FIGS. 1 to 4, was provided by Kuss Corporation, 215 Industrial Drive, Findlay, Ohio 45840. In this embodiment, the outer layer 114, of mesh cloth, forms the conductive element.

In the outermost layer, that is, the layer 114 defining the exterior surface of the strainer body 106, in direct contact with the fuel in the reservoir, a plurality of conductive strands 117 are employed, at spaced intervals. Each strand 117 is made of nylon impregnated with conductive material such as carbon powder. The strands 117 extend around the entire layer, and, because of the overmolding of the rigid components onto strainer body 106, contact the spine 110 and ribs 111 of rigid support member 102 as well as the connector flange 101 and ground link 108. Electrostatic charge is free to pass along the strands 117 to the rigid support member 102 and to ground through the connection collar 101 and ground link 108 to the conductive casing 29 of motor 30, which is connected internally to the system ground plane through the wires 34.

FIG. 5 illustrates an alternative, or modified form of strainer body 106. It is constructed of multiple layers of porous mesh cloth. Such mesh may be spun-bonded mesh, as previously described. The strainer is contemplated to also include some of the conductive rigid components formed of molded acetel or nylon, including connection flange 101 having a ground link 108. Flange 101 would be connected to strainer body 106, as described in connection with FIGS. 1 to 4. A rigid support member, such as that described and illustrated in connection with FIGS. 1-4, may also be used. However, any suitable arrangement may be employed to maintain the bag-like shape of strainer body 106.

In the embodiment illustrated in FIG. 5,, three layers are employed; an outer, or exterior, layer 214, an intermediate layer 215, and an inner layer 216. Each mesh layer has pores or openings which are approximately 40-60 microns in size. Use of three separate layers of this form of porous cloth creates an effective barrier to particles present in the fuel supply. This is a known construction for fuel inlet strainers and is commonly employed.

In this invention, however, at least one of the layers 214 to 216, preferably the exterior layer 214, of porous mesh, is conductive. It is formed of nylon containing carbon powder. Layer 214 can accumulate electrostatic charges resident in the area adjacent the strainer body. These charges are communicated to ground through the conductive connector flange 101 and ground link 108.

The features of the invention have been illustrated in the context of an inlet strainer on the fuel inlet to the pump that provides pressurized fuel to the fuel supply system. Other options are contemplated. For example, in reference to FIGS. 1-4, a strainer assembly similar to the inlet strainer assembly 100, could be associated with the siphon inlet port 54 of the aspirator 50. It would include conductive media that would be grounded to ground plane through a wire or the like.

In the arrangement as described, with the strainer assembly 106 on the inlet port 54, fuel drawn from the fuel tank 12 would be filtered initially by the strainer assembly associated with the siphon inlet port 54. Any electrostatic charge accumulating in the area of the strainer body would be directed to ground by virtue of the presence of conductive media in the strainer body, and its connection to the ground plane.

Various features of the invention have been shown and described in connection with the illustrated embodiments. Nevertheless, variations and modifications are contemplated without departing from the scope of the appended claims.

In this regard, it must be recognized that the invention, in its broad application, is directed to provision of a dissipation path from fuel that is actively moving, but not under pressure, such as experienced at the inlet side of the pump. That is, a conductive element, connected to the ground plane and associated with the inlet side of the fuel pump, is the essence of the contribution made by this invention. It is embodied, for exemplary purposes, in the fuel inlet strainer assembly of the fuel pump, or associated with the reservoir can delivery aspirator. Such specific constructions are not the limit of the invention, but, rather, specific examples of its application.

What is claimed is:

1. In a fuel supply system having a container for a supply of fuel, a pump, for pumping fuel from the container to the remainder of the system, and a motor to drive the pump, wherein the pump has an inlet open to the quantity of fuel in the container,
an electrostatic charge accumulation and dissipation mechanism including a porous member interposed between the supply of fuel in the tank and the inlet to the pump, at least a portion of said porous member being conductive, and
a grounding member connected to said porous member and adapted to be connected to a ground plane.

2. In a fuel supply system as claimed in claim 1 wherein said electrostatic charge accumulation and dissipation is;
a strainer for a fuel system, said strainer comprising;
a connection flange for connection to a fuel inlet;
a strainer body made of porous material secured to said connection flange to define a hollow bag-like filter;
at least a portion of said body made of electrically conductive material.

3. A strainer for a fuel system pump as claimed in claim 2 wherein said flange includes a grounding link in contact with said strainer body and adapted to be disposed in contact with a ground plane.

4. A strainer for a fuel system as claimed in claim 3 wherein said connecting flange and said connecting link are formed of polymeric resin containing conductive material.

5. A strainer for a fuel system pump as claimed in claim 4 wherein said conductive material is carbon powder.

6. A strainer for a fuel system pump as claimed in claim 5 wherein said polymeric resin is acetel.

7. A strainer for a fuel system as claimed in claim 2 wherein said strainer body is made of at least one layer of cloth mesh.

8. A strainer for a fuel system pump as claimed in claim 7 wherein said cloth mesh is formed of a non-conductive, polymeric resin containing conductive material.

9. A strainer for a fuel system as claimed in claim 8 wherein said conductive material is carbon powder.

10. A strainer for a fuel system pump as claimed in claim 7 wherein said cloth mesh is made of nylon containing a conductive material.

11. A strainer for a fuel system pump as claimed in claim 8 wherein said cloth mesh is made of nylon containing a conductive material.

12. A strainer for a fuel system pump as claimed in claim 10 wherein said conductive material is carbon powder.

13. A strainer for a fuel system pump as claimed in claim 11 wherein said conductive material is carbon powder.

14. A strainer for a fuel system comprising:
a connection flange for connection to a fuel inlet;
a strainer body made of porous material secured to said connection flange to define a hollow bag-like filter;
at least a portion of said body made of electrically conductive material.

15. A strainer for a fuel system pump as claimed in claim 14 wherein said flange includes a grounding link in contact with said strainer body and adapted to be disposed in contact with a ground plane.

16. A strainer for a fuel system as claimed in claim 15 wherein said connecting flange and said connecting link are formed of polymeric resin containing conductive material.

17. A strainer for a fuel system pump as claimed in claim 16 wherein said conductive material is carbon powder.

18. A strainer for a fuel system pump as claimed in claim 17 wherein said polymeric resin is acetel.

19. A strainer for a fuel system as claimed in claim 14 wherein said strainer body is made of a cloth mesh.

20. A strainer for a fuel system pump as claimed in claim 19 wherein said cloth mesh is formed of a non-conductive, polymeric resin containing conductive material.

21. A strainer for a fuel system as claimed in claim 20 wherein said conductive material is carbon powder.

22. A strainer for a fuel system pump as claimed in claim 19 wherein said cloth mesh is made of nylon containing a conductive material.

23. A strainer for a fuel system pump as claimed in claim 20 wherein said cloth mesh is made of nylon containing a conductive material.

24. A strainer for a fuel system pump as claimed in claim 22 wherein said conductive material is carbon powder.

25. A strainer for a fuel system pump as claimed in claim 23 wherein said conductive material is carbon powder.

26. A method of providing protection against electrostatic discharge in a fuel supply system having a container containing a quantity of fuel,
a pump for pumping said fuel from the container to the remainder of the fuel supply system, and
a motor to drive the pump,
wherein the pump has an inlet open to the quantity of fuel in the container, the method comprising:
providing an electrostatic charge accumulation and dissipation mechanism, including a porous member, at least a portion of which is conductive, and a grounding member connected to said porous member and adapted to be connected to a ground plane,
interposing said porous member between said fuel in said tank and said pump inlet and;
connecting said grounding member to a ground plane.
